(19) United States
(12) Patent Application Publication
(10) Pub. No.: US 2008/0093808 A1
(43) Pub. Date: Apr. 24, 2008

(54) Metallic Flat Gasket

(76) Inventors: Lothar Quick, Nersingen (DE); Jurgen Schneider, Merklingen (DE); Harald Plebst, Voehringen/Thal (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/572,353

(22) PCT Filed: Jul. 14, 2005
(86) PCT No.: PCT/EP05/07674

§ 371 Date: Jan. 19, 2007

(30) Foreign Application Priority Data
Jul. 19, 2004 (DE) 10 2004 034 824.3

(51) Int. Cl. F16J 15/08; B23K 26/00

(52) U.S. Cl. 277/595; 277/592; 29/888.4

(57) ABSTRACT

The present invention relates to a metallic flat gasket (1) having at least one gasket layer (2), in which at least one through opening (3) is located, which is enclosed by a sealing element (4) and at least partially has a surface structure (6) on one of its surfaces in the region of the sealing element (4). The surface structure comprises multiple depressions (7) which are positioned neighboring one another and are obtainable by irradiating the surface using laser radiation. The surface structure (6) is outstandingly suitable as a substrate for a coating (11) or an elastomeric sealing element (4). Furthermore, the present invention relates to a method of manufacturing the gasket (1).

The present invention relates to a metallic flat gasket having at least one gasket layer, in which one or more through openings are located. The at least one through opening is enclosed by a sealing element for sealing, which is typically a bead molded into the gasket layer and/or an elastomeric bead (elastomeric profiled sealing element) which is sprayed on or injection molded. The bead may deform plastically and elastically and thus ensures sufficient sealing of the through opening closed by the bead in the event of changes of the sealing gap.

In order to further improve the micro-sealing, metallic bead gaskets are frequently provided with a coating, at least in the region of the beads enclosing the through openings. Elastomeric profiled gaskets are also plastically and elastically deformable; they produce a combination of macro-sealing and micro-sealing. Elastomeric profiled sealing elements are not only applied to the surfaces of the metallic gasket layers (on one or both sides), but rather may also be injection molded at the inner edge of the through opening. Application extending from the top over the edge to the bottom is also possible, so that the inner edge of the metal plate projects into the elastomeric profiled sealing element.

In the following, both beads and also elastomeric profiled sealing elements are referred to as sealing elements, independently of the fact that the first may already be present before the pretreatment described in the following and the latter is only applied after the pretreatment.

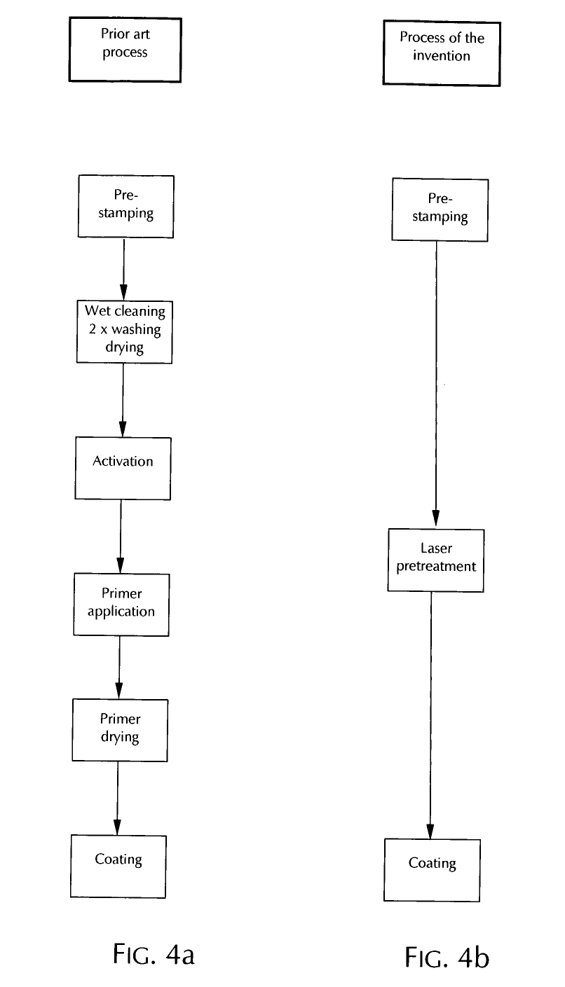

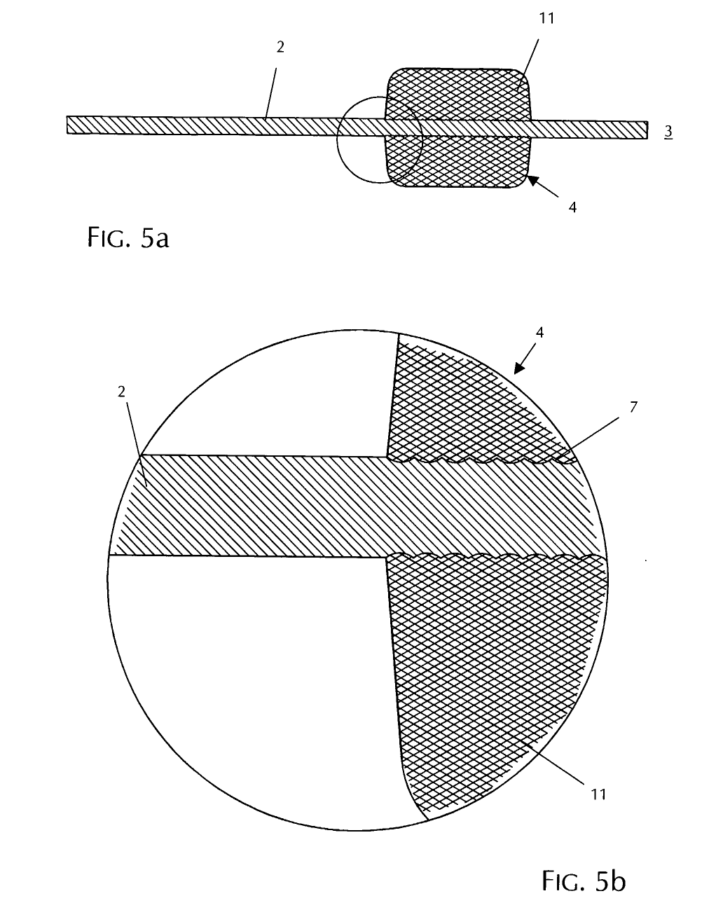

The material of the coating or the elastomeric profiled sealing element is frequently made of a natural or synthetic elastomeric material, such as a fluorinated rubber, silicone rubber, or NBR rubber. This coating and/or the elastomeric profiled sealing element are relatively soft and may thus adapt themselves outstandingly to surface roughness. However, it must be ensured that the coating and/or the elastomeric profiled sealing element is not abraded too easily from the gasket between the gasket and the counter surface to be sealed. In order to improve the adhesion of the coating and/or the elastomeric profiled sealing element on the gasket surface, until now multiple preparation steps were therefore necessary. Typically, the pre-stamped gasket, into which the bead(s) may already be embossed, was first degreased. The degreasing was typically performed in a wet cleaning method, which comprised at least two washing steps, using organic solvent, for example, and drying of the gasket blank. Subsequently, the gasket blank was treated to activate the gasket surface. A primer was then applied to the surface treated in this way as an adhesion promoter layer. After drying of the primer, the actual coating procedure and/or the application of the elastomeric profiled sealing elements could then occur. Such a typical coating procedure with its preparation treatments is schematically illustrated in FIG. 4a.

The coating method summarized in FIG. 4a is not only cumbersome, complex, and costly, but rather also harmful to the environment if organic solvent is used in the wet cleaning step. A further disadvantage is that because of different raw material qualities and different service lives of the cleaning bath resulting therefrom, an extremely cumbersome process control is necessary in order to obtain a qualitatively uniform coating result. A further grave disadvantage is that the primer used as the adhesion promoter layer is typically not particularly temperature stable. As a result of this, no powder coatings may typically be applied to the primer base, since these powder coatings must be fired at temperatures at which the primer is no longer stable. This also restricts the selection of the usable elastomeric materials.

Therefore, there is a need for a metallic flat gasket in which the above disadvantages do not occur. In particular, there is a need for a metallic flat gasket which may be provided cost-effectively and rapidly, in a few method steps, with a coating or an elastomeric profiled sealing element which has a good adhesion on the gasket surface. In addition, the coating and/or the elastomeric profiled sealing element are, as much as possible, to have good adhesion on the gasket even without primer application. The object of the present invention is accordingly to specify a gasket of this type and a method for its manufacture.

This object is achieved by the metallic flat gasket according to claim 1 and the method according to claim 27. Preferred embodiments and method variations may be inferred from the particular subclaims.

In a first aspect, the present invention thus relates to a metallic flat gasket having at least one gasket layer, in which at least one through opening is located which is enclosed by a sealing element. A surface structure is at least partially provided at least in the region of this sealing element on at least one of the surfaces of the gasket layer. The surface structure comprises multiple neighboring depressions, which are obtainable by treating the surface using laser radiation.

The gasket layer may consist of a single piece or may also consist of a carrier layer and at least one separate metal plate which is inserted into a respective opening of the carrier layer. This inserted separate metal plate will in the following also be called an “insert”. Most often, the inserts will contain through openings, especially oil and/or coolant water openings. In the present application, the term “gasket layer” is intended to cover both, a single-piece gasket layer and a gasket layer comprising at least one inserted separate metal plate (insert).

According to the present invention, the irradiation of the surface of the at least one metallic gasket layer is performed in such a way that a surface structure results on the surface which comprises multiple depressions positioned next to one another. The depressions form in this case through melting of the material of the gasket layer. Due to the heat generated as a result of the laser radiation, extremely fine particles made of metal or metal compounds are dissolved out of the surface and vaporized. A change of the physical surface structure in the material of the gasket layer apparently at least partially occurs in the region of the depressions. In some cases, there is also a chemical change of the material of the gasket layer. The surface treatment using laser radiation is expediently performed in such a way that there is no damage to the mechanical properties of the material of the gasket layer, nor undesired weakening of the gasket layer, however. In any case, however, the surface structuring using laser beams generates a larger surface than was present before the laser treatment. The laser-treated surface is typically rougher than the untreated surface. This surface enlargement and increased roughness appear to be the main reasons that a coating and/or the elastomeric profiled sealing element applied in the region of the surface structure have a significantly better adhesion than on the untreated surface.

This strongly improved adhesion on the metallic gasket layer was confirmed in different scratch tests after storing the coated gasket in different organic solvents. The coating also does not flow away as easily in the event of mechanical strain in the case of a gasket according to the present invention as in a typical flat gasket. The improvement of the adhesion is achieved without any further pretreatment of the metallic gasket layer. It is also not necessary to degrease the metallic gasket layer before the coating, nor must a primer be applied as an adhesion promoter. The six-step coating method typical up to this point may thus be shortened to only three steps, which is schematically illustrated in FIG. 4b. In addition to the savings in cost and time, it is additionally advantageous that organic solvent for degreasing and the primer as the adhesion promoter may be dispensed with. The metallic flat gasket according to the present invention and the method according to the present invention are therefore also significantly advantageous in relation to the method of the related art from environmental aspects.

It is only to be noted here for the sake of clarity that the production of a surface structure using laser beams according to the present invention has nothing to do with the laser cleaning method, which has also already been applied in metallic flat gaskets. Such a surface cleaning method is described, for example, in DE 19900910 A1. Therein, laser beams are used for the purpose of removing dirt or cover layers present on a metallic surface. In this case, the laser beam is intentionally set in such a way that the base material on which the cover layers are located is not changed. In contrast to this, in the present invention, the base material, i.e., the metallic gasket layer, which is to be coated, is changed, in that neighboring depressions are melted into the surface.

The present invention is suitable in principle for all metallic flat gaskets which have at least one metallic gasket layer. The metallic gasket layer may, for example, comprise any type of steel, such as carbon steel. Stainless steel is especially suitable as the material of the gasket layer. The surface structure produced through laser treatment is expediently located at least in all areas which are to be provided with a coating and/or an elastomeric profiled sealing element. These are typically at least those regions which come into contact with one of the counter surfaces to be sealed. Since this contact typically occurs in the region of the sealing element, the surface structure is at least partially provided in the region of at least one sealing element of the flat gasket according to the present invention. It may be sufficient in this case to only provide the surface structure where contact of the sealing element with the counter surface to be sealed or a neighboring gasket layer is to be expected. However, the region of the surface structure is expediently expanded laterally beyond this region and also provided over the entire length of the sealing element.

Above all, beads or sealing elements made of elastomeric material which are molded into the gasket layer come into consideration as suitable sealing elements. Of course, the different types of sealing elements may also occur in combination in a gasket—i.e., for example, in the case of a cylinder head gasket, beads as sealing elements for the combustion chamber openings and elastomeric profiled sealing elements for screw, coolant water, and oil openings. The elastomeric profiled sealing elements may, however, also be combined with other combustion chamber sealing elements as beads, specifically combustion chamber rings, for example.

If the sealing element is a bead, the width of the surface structure extends at least over the region of the bead apex, the bead flanks, and the bead foot, but may, however, also be expanded laterally beyond the region of the bead foot. If the sealing element is an elastomeric profiled sealing element, the surface structure preferably extends at least over the contact surface of this profiling on the gasket layer, but it may also be expanded laterally beyond the contact region here. If the sealing element is contained on a separate metal plate (insert) carrying one or more elastomeric profiled sealing elements, the surface structure preferably extends at least over the contact surface of this profiling on the insert, but it may again also be expanded laterally beyond the contact area. It is even possible for the surface structure to extend over the whole separate metal plate. In principle, the sealing element may otherwise, as is typical in the related art, run around one single or multiple through openings for fasteners, gas, or liquid and enclose them. If multiple through openings are sealed jointly, a sealing element frequently runs in proximity to the external edge of the gasket. Preferred metallic flat gaskets in which the surface structure according to the present invention may be used are, for example, manifold gaskets and cylinder head gaskets. In the latter, the sealing element may, for example, be a bead which encloses one of the cylinder openings of the flat gasket and/or a bead which encloses one or more oil or coolant water openings. Because of their thermal properties, elastomeric profiled sealing elements may not be used for sealing passages for combustion gases. All of these sealing elements are preferably provided completely with a surface structure in the region of the sealing elements at least on the side of the gasket layer which faces toward the component to be sealed or the insert, respectively.

In addition or alternatively thereto, the surface structure may also be provided in the region of the gasket outer edge or, if elastomeric profiled sealing elements on the single-piece layer or on the inserted separate metal plate(s) are used as the sealing elements, in the region of the inner edge of a screw, oil, or coolant water opening. The elastomeric profiled sealing element may only be applied on the edge in this case, but may also be applied reaching from the top around the edge to the bottom. It may be sufficient in this case to only apply the surface structure partially. For example, it may be sufficient to provide the surface structure on only one or both tops of the gasket layer, but not in the front region around the opening which lies between the two tops. In the case of the surface structure in the edge region of the gasket, it is preferable in principle to have the surface structure run along the entire gasket edge, above all if a sealing element like a peripheral bead is provided in the entire edge region of the gasket. The surface structure is thus preferably provided everywhere sealing elements are present in the gasket layer, in the form of beads or elastomeric profiled sealing elements, for example. A strip-shaped course of the surface structure over the surface and/or edge of the gasket layer expediently results therefrom.

If the metallic flat gasket comprises multiple gasket layers, the surface structure according to the present invention may be provided on only one or on multiple gasket layers. The surface structure is expediently at least provided on the surfaces which face toward the counter surfaces to be sealed in the installed state of the gasket. The surface structure may also be provided on gasket layers which do not comprise sealing elements. In this respect, reference is made, for example, to DE 19704315 A1, in which one of the gasket layers facing toward a counter surface has no sealing elements, but is at least partially provided with a plastic and elastic coating. The surface structure also offers outstanding adhesion conditions for the coating here. However, surface structures may also be provided on the inner gasket layers. The surface structures may be provided only partially or even over the entire area of the surface of the gasket layer. However, the latter is generally not preferable because of the increased costs during manufacturing.

In the case of coating bead seals, the surface structure may be produced in principle on the metal blank in practically any method stage before the coating, i.e., before or after the individual gasket layers are stamped out of a metal plate or before or after the embossing of beads or other metal processing steps. In general, however, it is preferable to produce the surface structures after completion of the stamping steps, which is, of course, necessary for elastomeric profiled seals on the inner edge of through openings or on the gasket outer edge. In the case of a gasket layer consisting of a carrier layer and at least one inserted separate metal plate, it is preferable to introduce the surface structures as well as to apply the elastomer before the at least one separate metal plate is inserted according to the techniques known from the state of the art.

The depressions which form the surface structure may be produced in principle in the form of greatly varying regular or irregular point rasters on the surface of the gasket layer. For this purpose, the laser beam from a laser beam source is repeatedly focused on the region of the surface of the metallic gasket layer in order to produce the neighboring depressions. From a method economy aspect, it is preferable to produce essentially regular patterns of depressions on the surface. The laser beam is expediently guided linearly over the surface for this purpose, in order to thus produce rows of depressions lying one behind another. Multiple rows of depressions are preferably produced essentially parallel to one another using the laser beam. It is also possible to combine different patterns, for example, small rasters in the outer region of the coating and/or contact surface and coarser rasters in the core region or vice versa.

The method for producing the surface structure may be accelerated if the laser beam emitted from the laser beam source is divided into multiple partial beams. For example, by positioning beam splitters, the originally generated laser beam may be divided into two or four partial beams, which are focused simultaneously onto the surface of the gasket layer in order to thus produce two or four depressions in the gasket surface at the same time. In principle, arbitrarily many partial beams may be focused on the surface of the metallic gasket layer simultaneously. In practice, however, the number of partial beams is restricted by the power of the base beam. If the base beam is split too strongly, the power of the partial beams is too low to produce depressions in the gasket layer by melting the surface.

The selection of the laser beam source which may be used according to the present invention is not especially restricted in principle. All of those laser beam sources which have sufficient power to produce depressions of suitable size and depth in the material of the gasket layer may be used. In the present invention, a pulsed laser is preferably used as the laser beam source. Solid-state lasers and particularly Nd-YAG lasers have been shown to be especially suitable here.

The guiding and steering of the laser beam over the surface of the metallic gasket layer may be performed exclusively with the aid of the lens of the laser device. For this purpose, for example, deflection mirrors may be set in such a way that the laser beam is steered sequentially to the individual positions at which depressions are to be produced in the gasket surface. In this case, the depressions will have a more or less oval shape, since the laser beam is typically not incident vertically on the gasket surface. The outer edge is always longer than that of an ideal oval in this case. In addition to discrete ovals, linear sections may also form. Flowing together of multiple parallel sections is also conceivable. Alternatively, it is possible to displace the beam outlet opening of the laser device and the gasket in relation to one another in order to apply depressions at the desired positions on the surface of the gasket layer. It is possible in principle in this case to displace the workpiece itself, the beam outlet opening, or both. If the beam outlet opening is displaced, those laser devices which have a movable processing head may advantageously be used. Such devices are described, for example, in DE 19900910 A1 and in DE 10113494 A1. Therein, the laser light from the laser beam source is introduced via a flexible optical fiber into a processing head having a decoupling lens. If desired, the laser beam may be divided into multiple partial beams in this processing head. The processing head may be moved well and may be traversed, for example, via a suitable traverse frame to any desired position above the gasket surface to be processed. This movement is preferably computer-controlled. The laser device allows a continuous pretreatment of gaskets within a progressive tool.

In a refinement of the present invention, the production of the depressions through laser radiation is controlled using an imaging method. For this purpose, for example, a suitable camera is positioned above the gasket surface to be processed, which transmits images to a suitable analysis device either continuously or at predefined intervals. In the simplest variation, this analysis device may comprise a display screen that reproduces the image of the gasket surface, which is then analyzed by monitoring personnel. In another variation, the image registered by the camera is analyzed using an image processing program implemented in a computer. Faults during the production of the surface structure on the gasket surface may thus be established automatically and possibly corrected during the processing. Alternatively, the laser processing may be interrupted in the event of a fault message.

The possibility of visual method controls represents a significant advantage in relation to the typical surface processing methods before the coating of a metallic gasket layer. In the currently typical degreasing method with the aid of organic solvent in cleaning baths, visual control was completely excluded. In addition, it was also not possible to treat the surface only partially. This is easily possible using the method according to the present invention. It is conceivable in principle, as noted, to provide the entire surface of the metallic gasket layer with the surface structure and produce point rasters from laser-generated depressions on one or even both surfaces. However, it is typically completely sufficient and shortens the laser treatment significantly if depressions are only generated in the regions in which a coating and/or an elastomeric profiled sealing element is to be applied to the gasket layer in the following method step.

The way in which the depressions are introduced into the gasket layer is decisively dependent on the type of surface to be treated, the planned use of the gasket, and the type and dimensions of the coating which is to be applied to the gasket layer. In principle, the tendency is to be observed that the adhesion of the coating is better the larger the number of depressions which are generated on a predefined area. However, the processing time also increases with increasing number of depressions. Typically, substrates having outstanding adhesion are obtained if the size of the individual depressions is in a range from 0.0001 to 0.5 mm². Depressions of a size from 0.0005 to 0.1 mm² are preferred and particularly those from 0.0008 to 0.08 mm². The number of depressions per square centimeter of surface of the gasket layer moves in the range from approximately 500 to 500,000 and preferably 4000 to 300,000. Approximately 15 to 90%, preferably 20 to 60%, and particularly 25 to 50% of the surface of the gasket layer which is provided with a surface structure is to be provided with depressions.

The depth of the depressions, measured from the untreated surface of the gasket layer to the lowest point of the depression, is typically in a range from 0.1 to 30 μm. The depth is preferably 0.3 to 20 μm and particularly 0.5 to 10 μm. Depths of 0.6 to 3 μm are especially preferred. In some cases, especially if lower power per unit area and higher focusing are used, crater edges which project above the untreated surface form during the production of the depressions around their peripheral edge. These crater edges may have a height of approximately 2 μm or even more, measured from the untreated surface. The height of these crater edges is also taken into consideration in the present specification of the depth of the depressions, i.e., if crater edges are present around the depressions, the depth of the depression is specified from the apex of the crater edge to the lowest point of the depression.

In the event of higher power per unit area and larger diameters of the depressions, the crater edges are typically not observed. In some cases, it may therefore be expedient to use a somewhat higher-power laser for producing the depressions in order to avoid crater edges. Undesired fretting (digging into the counter surface) and undesired occurrence of fractures may thus be suppressed. With higher-power lasers, warped material is observed more often in the laser treatment region, which does not occur with lower-power lasers. This warped material and irregular roughness of the treated region connected therewith typically does not represent any kind of disadvantage, however.

Targeted modifications of the laser-treated surface may also be generated by performing the laser irradiation in a suitably selected gas atmosphere. The laser treatment is typically performed in the ambient atmosphere (air). However, it is also possible to perform the laser treatment in a gas-filled chamber in order to achieve a targeted chemical change of the treated surface or, vice versa, to suppress changes which occur in air. Examples of suitable gases are inert gases such as nitrogen or argon and reactive gases such as hydrogen.

The regions of the gasket layer provided with the surface structure represent an outstanding substrate for applying coatings or elastomeric profiled sealing elements. Neither degreasing nor activation treatment nor the application of a primer as an adhesion base are necessary for this purpose. The surface structure according to the present invention improves the adhesion of practically all coatings which have been used until now for coating metallic gasket layers in a metallic flat gasket. Thus, for example, the adhesion of elastomeric coatings or elastomeric profiled sealing elements is significantly improved in particular. All those elastomeric coatings which improve the micro-sealing and/or the coefficient of sliding friction may be cited as examples. Elastomeric coatings such as those made of fluoropolymers, for example, FPM (vinylidene fluoride hexafluoropropylene copolymer), silicone rubber or NBR rubber (acrylonitrile-butadiene rubber), PUR (polyurethane), NR (natural rubber), FFKM (perfluorinated rubber), SBR (styrene-butadiene rubber), BR (butyl rubber), FVSQ (fluorosilicone), CSM (chlorosulfonated polyethylene), and silicon or epoxide resins are cited only as examples. These coating materials may be applied in the currently typical way to the surface-structured regions of the gasket layer. Screen printing is especially suitable for this purpose. Alternate application methods for the above-mentioned coating materials comprise curtain coating and spraying.

Elastomeric profiled sealing elements are typically sprayed on or injected using pressure casting, transfer casting, or injection molding. In this case, for example, fluoropolymers (e.g., FPM, PFA, and MFA), NBR rubber (acrylonitrile-butadiene rubber), EPDM (ethylene-propylene rubber), ACM (polyacrylate), or EAM (ethylene acrylate) are used. It may be expedient in this case not to apply the coating and/or the elastomeric profiled sealing elements completely up to the edge of the surface-structured regions, in order to ensure that the coating is applied in every case to a surface region of the gasket layer equipped with depressions. It is therefore advisable to provide the surface-structured regions somewhat more broadly than the coating and/or the elastomeric profiled sealing elements are to be applied to the gasket layer.

The surface-structured regions of the metallic flat gasket according to the present invention are additionally outstandingly suitable as a substrate for powder coatings. In the case of powder-coating metallic flat gaskets, the problem frequently resulted of insufficient adhesion, since primer may typically not be used in combination with powder coatings as an adhesion promoter. The problem is that the typical primers already decompose at temperatures which are lower than the firing temperatures necessary for the powder coatings. This problem does not occur with the metallic flat gaskets according to the present invention, since no primer is necessary. The following are cited as examples of coating materials for the powder coating: polyester resins, PEEK (polyether ether ketone), PTFE (polytetrafluorethylene), PFA and MFA (both fluoroelastomers), as well as silicone or epoxide resins.

The thickness of the coating is primarily oriented to the type of the coating itself, the substrate used, and the planned use of the gasket. The coating is expediently to be thick enough that it sufficiently covers even the elevated points of the surface structure, for example, possible crater edges. Suitable coating thicknesses are generally in a range from 2 μm to 250 μm. If the coating is applied using screen printing, curtain coating, or spraying, coating thicknesses of preferably 3 μm to 50 μm and more preferably 5 to 40 μm result. If the coating is applied using powder coating, the coating thickness is preferably 70 μm to 200 μm and especially preferably 100 to 150 μm.

The thickness of the elastomeric profiled sealing elements primarily depends on the planned use. The total thickness of the gasket having elastomeric profiled sealing elements on one or both sides is in the range from 0.4 to 5 mm. Typical bead widths of elastomeric profiled sealing elements range from 2 to 6 mm. The elastomeric profiled sealing elements project between 2 and 3 mm beyond the inner edge of the through opening or the gasket outer edge so they seal at the inner edge of through openings or the gasket outer edge.

The present invention is to be described in greater detail in the following on the basis of the drawing. The drawing merely describes some special embodiments of the present invention for exemplary purposes, without the present invention being restricted thereto, however. In the drawing:

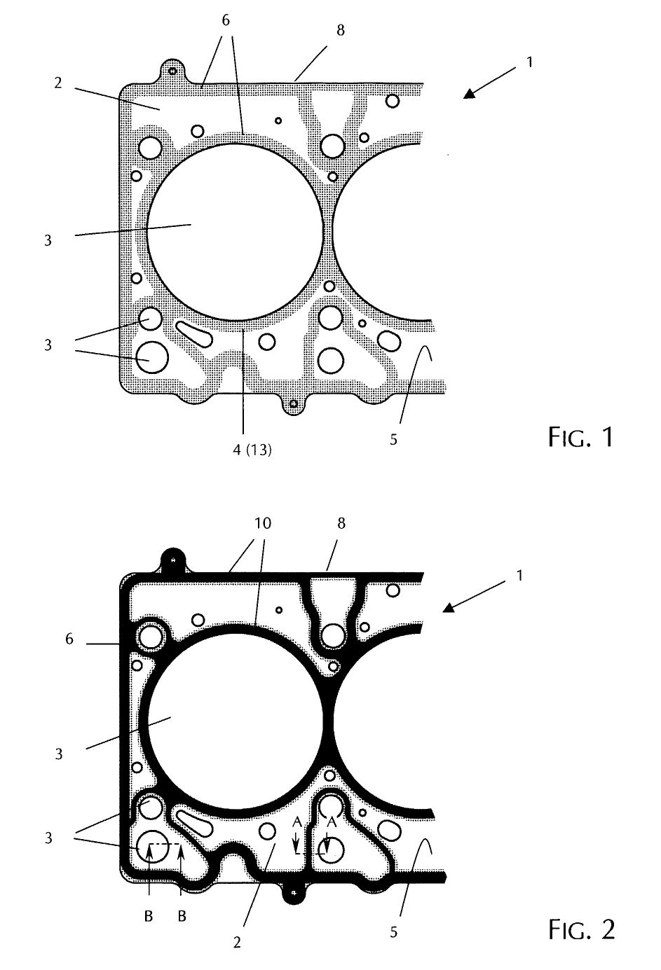

FIG. 1 schematically shows a partial top view of a metallic flat gasket according to the present invention in the example of a cylinder head gasket;

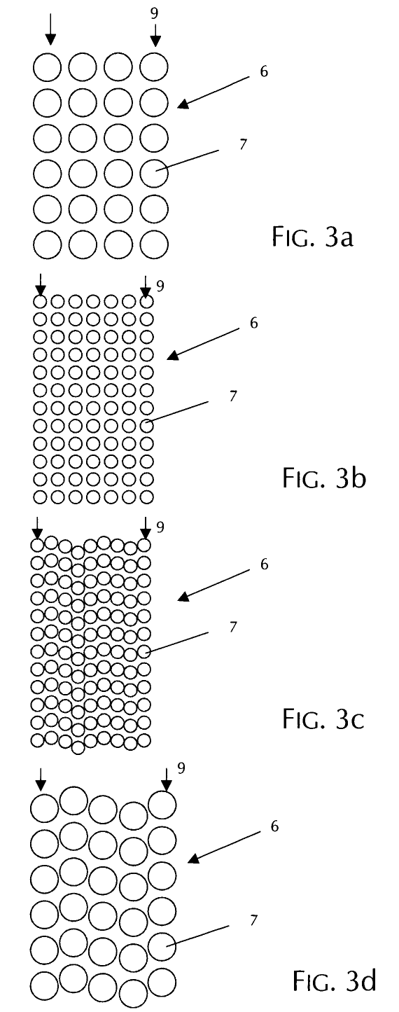

FIG. 2 schematically shows the cylinder head gasket shown in FIG. 1, now provided with a coating;

FIGS. 3a-3d schematically show details of surface structures according to the present invention in an idealized top view;

FIGS. 4a and 4b schematically show flowcharts of the method sequence during the coating of metallic flat gaskets according to the methods in the related art and according to the present invention;

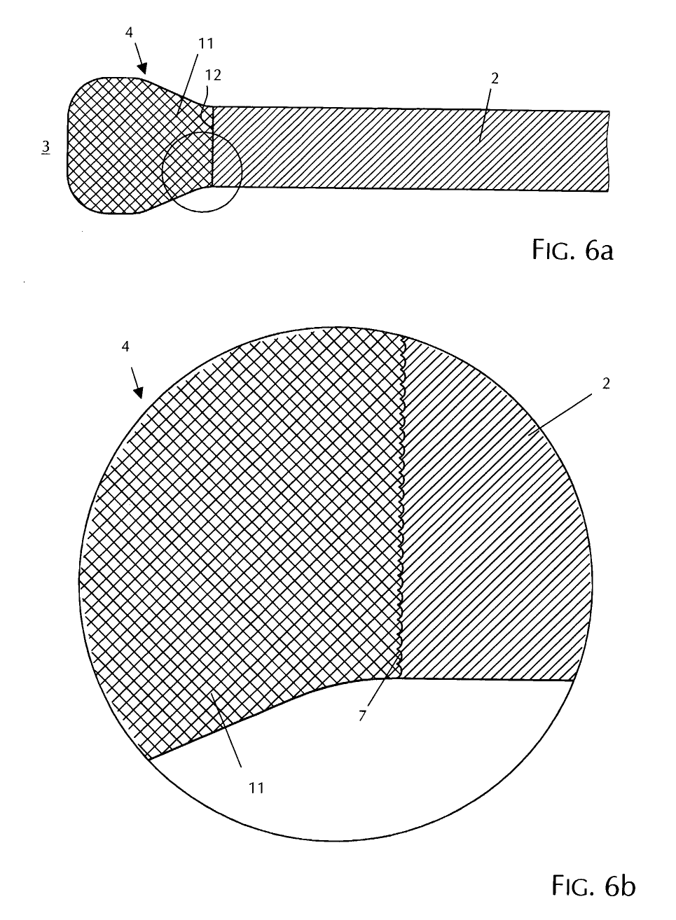

FIG. 5a schematically shows a cross-section through a further embodiment of a metallic flat gasket according to the present invention along the line A-A in FIG. 2;

FIG. 5b schematically shows an enlarged illustration of the circled region of FIG. 5a;

FIG. 6a schematically shows a cross-section through another embodiment of a metallic flat gasket according to the present invention along the line B-B in FIG. 2;

FIG. 6b schematically shows an enlarged illustration of the circled region of FIG. 6a;

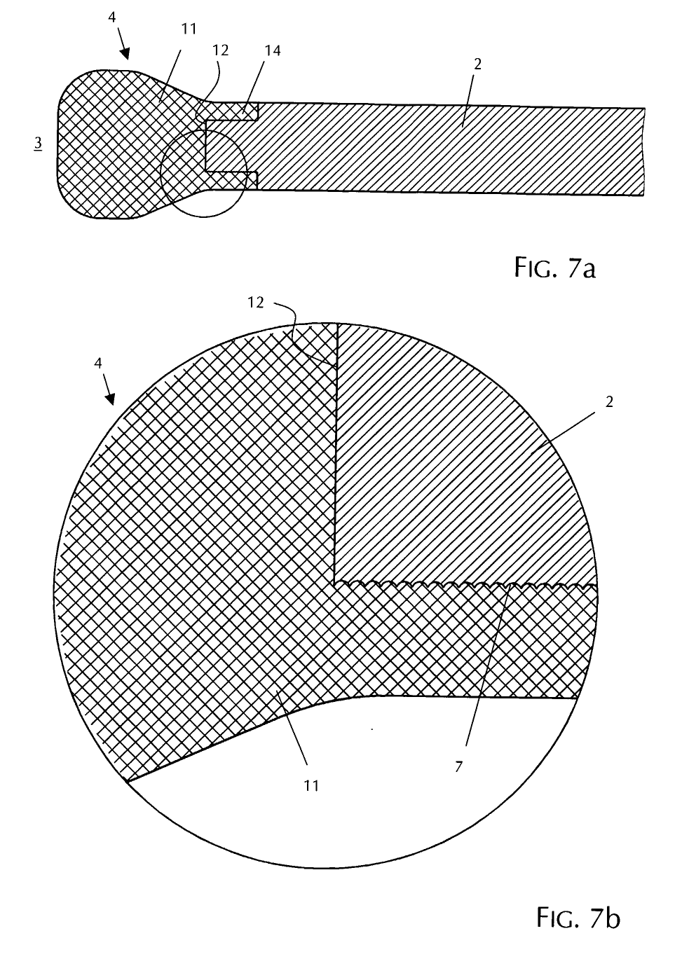

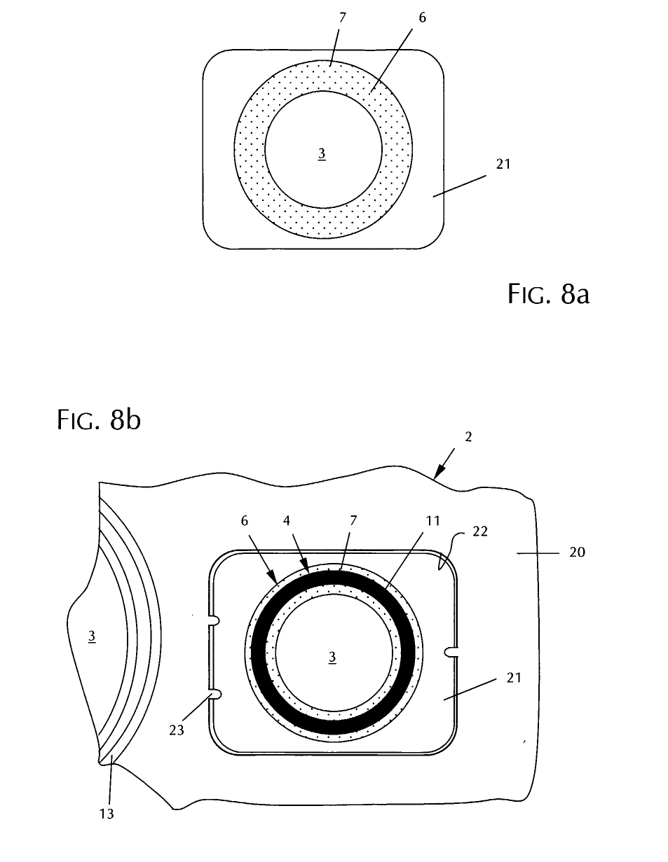

FIG. 7a schematically shows a cross-section through a further embodiment of a metallic flat gasket according to the present invention along the line B-B in FIG. 2;

FIG. 7b schematically shows an enlarged illustration of the circled region of FIG. 7a;

FIG. 8a schematically shows a top view of a pre-stage of a separate metal plate to be inserted into an opening in a metallic carrier layer; and

FIG. 8b schematically shows the completed separate metal plate of FIG. 8a inserted into the opening of the metallic carrier layer.

FIG. 1 shows a metallic flat gasket 1 according to the present invention in the example of a cylinder head gasket in a partial view. The top view of an outer metallic gasket layer 2 is shown. However, this does not exclude the gasket having further gasket layers which are not shown here. The gasket 1 has multiple through openings 3, of which the largest, centrally positioned openings are combustion chamber openings. Only one combustion chamber opening is shown in its entirety here and one is shown partially, while the complete gasket layer 2 has four combustion chamber openings positioned in a row, for example. Further through openings 3 are provided around the combustion chamber openings toward the edge 8 of the gasket layer 2, which are openings for coolant liquid and oil. In addition, screw openings are provided, which are not shown in greater detail here. The through openings 3 are enclosed by sealing elements 4. These sealing elements 4 are beads which are molded into the gasket layer 2. The beads project out of the image plane in the direction toward the observer. Each individual one of the combustion chamber openings is enclosed by a per se closed bead 4. The lines indicated by 4 illustrate the course of the apex lines of the particular beads here, which run together in the region between neighboring combustion chamber openings into a single bead.

Surface structures 6 are provided in the region of the beads 4 enclosing the combustion chamber openings 3, which follow the course of the beads 4. The surface structures 6 cover the surface of the beads 4 completely, i.e., extend over the bead foot, the bead flanks, and the apex region of the beads. The surface structures 6 comprise multiple depressions 7, which are produced in the gasket layer by irradiating the surface 5 of the gasket layer 2 using laser radiation.

The depressions are positioned in multiple essentially parallel rows 9 to one another, which is schematically shown in FIGS. 3a through 3d. The figures each show partial regions of the surface structure 6. The continuing pattern sections result in the surface structure strips illustrated in FIG. 1. All idealized point rasters shown in FIGS. 3a through 3d were produced by guiding a laser beam linearly over the surface 5 of the gasket layer 2. The linear guiding is identified by the arrow at the upper left edge of the particular pattern. The laser beam is thus guided in the direction of the arrow over the surface 5 of the gasket layer 2 and melts the individual depressions 7 into the surface 5 one after another. Depending on the power and focusing of the laser beam, larger or smaller depressions result in this case, which may also be implemented having different depths depending on the power input. The individual depressions 7 are preferably implemented approximately equally large and deep within a particular pattern. However, it is also conceivable to vary the size and depth of the depressions 7 within a pattern. In all of the cases shown, the laser light is irradiated essentially perpendicularly from above, so that round depressions result.

After producing the first row of depressions 7, the neighboring rows 9 of depressions 7 are produced one after another. For this purpose, the laser beam may be guided in the same direction as in the preceding row. For example, a through opening 3 may be traveled around multiple times in a spiral, in order to provide multiple neighboring rows of depressions 7. Alternatively, it is also possible to reverse the running direction of the laser beam at the end of a particular row and return it in the opposite direction. In both cases, an offset in relation to the neighboring rows 9 may result if the beginning of the further rows does not lie at the same height as that of the neighboring rows. This is shown in FIGS. 3c and 3d. With the aid of targeted laser beam guiding, the distortions of the gasket layer produced through the laser process may be minimized.

As shown in FIG. 1, strip-shaped surface structures are present not only around the combustion chamber openings 3, but rather also around the through openings for oil and coolant water located in the edge region. Frequently, multiple through openings are enclosed by a strip of depressions 7, which is closed per se, here. The beads, which also enclose these through openings as sealing elements, are not shown for the sake of simplicity. However, they lie below the surface structure strips, the apexes of the beads running approximately in the middle of each strip. In addition, a bead (also not shown) is provided around the circumference of the bead edge, on whose surface a surface structure 6 in the form of a strip of neighboring depressions 7 is also located.

FIG. 2 shows the gasket shown in FIG. 1, after a coating 10 was applied to regions of the gasket layer 2 provided with the surface structure 6. This coating 10 is, for example, a synthetic rubber made of FPM, NBR, or silicone, which improves the micro-sealing and the sliding friction properties of the gasket. The coating 10 was applied in a screen printing method. It is obvious that the strips of the coating 10 are somewhat narrower than the strips of the surface structure 6, which projects laterally below the coating 10. The reason for this is that it is to be ensured that the coating 10 is only located on those regions of the surface 5 of the gasket layer 2 in which a surface structure 6 is actually present. In this way, the coating 10 adheres excellently to the metallic gasket layer 2 and is thus more abrasion-resistant and better protected against flowing away than a typical coating applied according to the method steps shown in FIG. 4a.

FIG. 4b again schematically illustrates the advantages of the method according to the present invention in relation to the typical method shown in FIG. 4a. In contrast to the method of the related art, in the method according to the present invention, all chemical pretreatment steps are dispensed with, and only a pretreatment using laser radiation is necessary in order to provide an outstanding adhesion base for all typically used coatings and/or elastomeric profiled sealing elements. In contrast to the related art, powder coatings may also be used.

FIGS. 5a through 7b show examples of metallic flat gaskets according to the present invention in the example of cylinder head gaskets in cross-sectional illustrations around through openings which may be screw, oil, or coolant water openings. These openings are typically located in the edge region of the gasket. While the combustion chamber openings may be sealed using beads 13 as sealing elements 4, for example, as in the preceding examples, the oil and water openings and possibly also the screw openings are now sealed by sealing elements 4 which comprise an elastomeric material 11.

In the example of FIGS. 5a and 5b, the elastomeric material 11 is applied on both sides of the gasket layer 2. The application may be performed through injection molding, for example, in order to produce elastomeric beads which completely enclose an oil or coolant water opening 3. In the case shown, two fluid openings 3 are sealed jointly by an elastomeric sealing element 4, which runs at a distance to the openings. A strip-shaped surface structure 6, which is formed by multiple neighboring depressions 7, is located on both sides of the gasket layer 2 in the region of the contact surface of the elastomeric material 11. The surface structure improves the adhesion of the elastomeric material on the gasket layer significantly in relation to an untreated substrate or a substrate pretreated in a typical way.

FIGS. 6a and 6b show another possibility for sealing fluid opening 3 using elastomeric profiled sealing elements. The sealing element 4 made of elastomeric material 11 is located here in the region of the inner edge of the fluid opening 3. The sealing element shown in FIG. 2, which runs at a distance to the opening 3, is no longer necessary in this case for sealing the opening. The elastomeric sealing element 4 is injected onto the inner edge 12 of the sealing plate 2. It has a greater thickness than the sealing plate 2 and projects past it on both sides. To improve the adhesion of the elastomeric material 11 on the inner edge 12, its surface is provided with a surface structure made of depressions 7.

FIGS. 7a and 7b show an alteration of the gasket shown in FIGS. 6a and 6b. In this case, the elastomeric material 11 of the sealing element 4 is drawn from the inner edge 12 of the gasket layer 2 onto both sides of the gasket layer. In order to obtain an essentially flush terminus with the gasket layer 2, annular grooves 14 are provided in the gasket layer 2 on both sides, originating from the inner edge 12, which are filled up with the elastomeric material 11. The surfaces of the grooves 14 are provided with a surface structure made of depressions 7. The front faces of the inner edge 12 and edges of the grooves 14 do not have depressions 7. This would be possible to further improve the adhesion of the elastic material 11 on the gasket layer 2, but makes the manufacturing procedure of the surface structure more difficult, since the radiation of the laser light must be performed from a different direction than in the irradiation of the horizontal surfaces in the illustration.

FIGS. 8a and 8b show another embodiment of the invention in which the sealing element 4 is provided on a separate metal plate 21. As in the previous embodiments, the through opening 3 to be sealed is surrounded by a surface structure 6 which is formed by multiple neighboring depressions 7 and which is located on both sides of the metal plate 21. FIG. 8a shows the separate metal plate 21 without elastomeric material, while in FIG. 8b elastomeric material 11 is applied onto the metal plate 21 in the region of the surface structure 6. As can be seen from FIG. 8b, the ring of elastomeric material 11 is somewhat narrower than the ring of the surface structure 6, which projects laterally below the elastomer 11. The elastomeric material 11 was applied onto both sides of the metal plate 21 before the plate was inserted into opening 22 of the carrier layer 20. Separate metal plates, also called inserts, are preferably used in case of large gasket layers. The inserts are much smaller than the whole gasket layer and can thus be handled more easily, particularly as regards coating steps or application of elastomeric material. The insert with the elastomer applied is then inserted into opening 22 of the carrier layer 20 which, together with the inserted metal plate 21, forms the metallic gasket layer 2. Inserted metal plate 21 and carrier layer 20 are essentially in the same plane, and the insert is held in the opening 22 by spot welding at the protrusions 23 of the carrier layer 20 which overlap with the insert 21. As can by taken from FIG. 8b, only part of the through openings 3 is provided on an insert. The large opening 3 on the left side of the figure and its sealing element are formed in the carrier layer 20. In this case, the opening is a cylinder opening which is surrounded by multiple concentric beads 13.

1-38. (canceled)

39. A metallic flat gasket, comprising:
at least one metallic gasket layer in which at least one through opening is located, wherein the through opening is enclosed by a sealing element, and
a surface structure that comprises multiple neighboring depressions, wherein the surface structure is at least partially provided on at least one surface of the gasket layer in at least the region of the sealing element, wherein the surface structure is obtainable through irradiation of the gasket surface using laser radiation, and the size of depressions is in a range from about 0.0001 to 0.5 mm².

40. The metallic flat gasket according to claim 39, wherein the sealing element comprises an elastomeric material that is at least partially applied to the gasket surface in the region of the surface structure.

41. The metallic flat gasket according to claim 40, wherein the elastomeric material is applied in the region of an edge of at least one through opening.

42. The metallic flat gasket according to claim 40, wherein the elastic material comprises fluoropolymers, particularly FPM, PFA, or MFA, NBR rubber (acrylonitrile-butadiene rubber), EPDM (ethylene-propylene rubber), ACM (polyacrylate), or EAM (ethylene acrylate).

43. The metallic flat gasket according to claim 39, wherein the sealing element is a bead embossed into the gasket layer.

44. The metallic flat gasket according to claim 43, wherein the surface structure completely covers the surface of the bead on at least one side of the gasket layer.

45. The metallic flat gasket according to claim 39, wherein the at least one metallic gasket layer further comprises a carrier layer and at least one separate metal plate that is inserted into an opening in a plane of the carrier layer.

46. The metallic flat gasket according to claim 45, wherein the separate metal plate contains at least one through opening therein for transmission of oil or coolant water.

47. The metallic flat gasket according to claim 45, wherein the surface structure completely covers at least one surface of the separate metal plate.

48. The metallic flat gasket according to claim 45, wherein the surface structure at least partially covers at least one surface of the separate metal plate.

49. The metallic flat gasket according to claim 39, wherein the sealing element encloses at least one single through opening for gas or liquid in a closed manner.

50. The metallic flat gasket according to claim 39, wherein the surface structure is at least partially provided in a gasket edge region.

51. The metallic flat gasket according to claim 39, wherein the surface structure is strip-shaped.

52. The metallic flat gasket according to claim 39, wherein the depressions are positioned in rows which are positioned generally parallel to one another.

53. The metallic flat gasket according to claim 39, wherein the depressions have a generally round or oval shape.

54. The metallic flat gasket according to claim 39, wherein the depressions are partially passing into one another in chains.

55. The metallic flat gasket according to claim 39, wherein the size of the depressions is in a range from about 0.0008 to 0.08 mm².

56. The metallic flat gasket according to claim 39, wherein there are approximately 500 to 500,000 depressions per square centimeter.

57. The metallic flat gasket according to claim 39, wherein there are approximately 4000 to 300,000 depressions per square centimeter.

58. The metallic flat gasket according to claim 39, wherein approximately 15% to approximately 90% of the gasket surface provided with the surface structure is occupied by the depressions.

59. The metallic flat gasket according to claim 39, wherein approximately 20% to 60% of the gasket surface provided with the surface structure is occupied by the depressions.

60. The metallic flat gasket according to claim 39, wherein approximately 25% to 50% of the gasket surface provided with the surface structure is occupied by the depressions.

61. The metallic flat gasket according to claim 39, wherein the depressions have a depth, measured from an untreated surface to the lowest point of the depression, wherein the depth is in the range from about 0.1 to 30 μm.

62. The metallic flat gasket according to claim 39, wherein the depressions have a depth, measured from an untreated surface to the lowest point of the depression, wherein the depth is in the range from about 0.3 to 20 μm.

63. The metallic flat gasket according to claim 39, wherein the depressions have a depth, measured from an untreated surface to the lowest point of the depression, wherein the depth is in the range from about 0.5 to 10 μm.

64. The metallic flat gasket according to claim 39, wherein the depressions have a depth, measured from an untreated surface to the lowest point of the depression, wherein the depth is in the range from about 0.6 to 3 μm.

65. The metallic flat gasket according to claim 39, wherein the depressions are at least partially enclosed by an edge projecting beyond the gasket surface.

66. The metallic flat gasket according to claim 39, wherein the surface structure is at least partially provided with a coating.

67. The metallic flat gasket according to claim 66, wherein the coating comprises an elastomeric material.

68. The metallic flat gasket according to claim 66, wherein the coating comprises FPM (vinylidene fluoride hexafluoropropylene copolymer), silicone rubber, NBR rubber (acrylonitrile-butadiene rubber), PUR (polyurethane), NR (natural rubber), FFKM (perfluorinated rubber), SBR (styrene-butadiene rubber), BR (butyl rubber), FVSQ (fluorosilicone), CSM (chlorosulfonated polyethylene), and silicon or epoxide resins.

69. The metallic flat gasket according to claim 66, wherein the coating is applied as a powder coating and fired.

70. The metallic flat gasket according to claim 69, wherein the coating comprises polyester resin, polyether ether ketone, fluoroelastomer, silicone resin, or epoxide resin.

71. The metallic flat gasket according to claim 1, wherein the at least one gasket layer is constructed of steel.

72. A method of manufacturing a metallic flat gasket, comprising:
providing a metallic gasket layer having at least one through opening therein;
focusing a laser beam from a laser beam source repeatedly on a region of a surface of the gasket layer to produce depressions thereon, wherein the depressions are positioned neighboring one another; and
enclosing each through opening with a sealing element.

73. The method according to claim 72, wherein rows of depressions lying one behind another are produced using the laser beam.

74. The method according to claim 73, wherein the rows of depressions are produced so as to be substantially parallel to one another using the laser beam.

75. The method according to claim 72, wherein the depressions are produced by melting the material of the gasket layer.

76. The method according to claim 72, wherein the laser beam is divided into multiple partial beams.

77. The method according to claim 72, wherein a pulse laser is used as the laser beam source.

78. The method according to claim 77, wherein the pulse laser is a solid-state laser.

79. The method according to claim 78, wherein the solid-state laser is a Nd-YAG laser.

80. The method according to claim 72, wherein the production of the depressions is controlled using an imaging method.

81. The method according to claim 72, wherein the application of the laser beam is performed in an atmosphere made of inert gas.

82. The method according to claim 81, wherein the inert gas is one of nitrogen or argon.

83. The method according to claim 72, wherein the sealing element is made of elastomeric material and is sprayed on or injected using pressure casting, transfer casting, or injection molding.

84. The method according to claim 72, wherein a coating is at least partially applied to a surface region of the gasket layer, after the depressions are formed.

85. The method according to claim 84, wherein the material of the coating is applied as a powder and fired.

86. The method according to claim 84, wherein the material of the coating comprises an elastomeric material and is applied using screen printing, curtain coating, or spraying.

87. The method according to claim 72, wherein the application of the laser beam is performed in an atmosphere made of reactive gas.
